(19) United States
(12) Patent Application Publication
(10) Pub. No.: US 2017/0235625 A1
(43) Pub. Date: Aug. 17, 2017

(54) DATA MINING USING CATEGORICAL ATTRIBUTES

(71) Applicant: Microsoft Technology Licensing, LLC, Redmond, WA (US)

(72) Inventors: Roy B. Ofer, Tel-Aviv (IL); Adi Eldar, Kiryat-Ono (IL); Yehezkel S. Resheff, Jerusalem (IL)

(21) Appl. No.: 15/183,339

(22) Filed: Jun. 15, 2016

Related U.S. Application Data
(60) Provisional application No. 62/294,596, filed on Feb. 12, 2016.

(51) Int. Cl. G06F 11/07; G06F 17/30

(52) U.S. Cl. CPC G06F 11/079; G06F 17/30598; G06F 17/30522; G06F 17/30539; G06F 11/0709; G06F 11/0751; G06F 11/0787

(57) ABSTRACT

Embodiments disclosed herein are related to determining patterns of related attributes in accessed or received data. Data that is associated with attributes that describe information corresponding to the data is accessed or received. The data is grouped into one or more subsets that include data having matching combinations of the attributes. For each of the subsets, attributes of the combination of attributes associated with the subset are iteratively removed to thereby increase the amount of data included in each subset. After iteratively removing the attributes, each subset is scored to determine one or more patterns related to the combination of attributes.

### CROSS-REFERENCE TO RELATED APPLICATIONS

This application is a non-provisional of and claims priority from and the benefit of U.S. Provisional Patent Application Ser. No. 62/294,596 filed on Feb. 12, 2016 and entitled “DATA MINING USING DISCRETE ATTRIBUTES,” which application is hereby expressly incorporated herein in its entirety.

### BACKGROUND

With the increasing transition of software applications from on-premises to cloud based solutions, telemetry data is collected more than ever and Application Performance Management (APM) is becoming an increasingly important part of software applications' success. With the increase of APM, there is also a growing need for log analysis, especially the analysis of failures. The ability to efficiently mine failure logs may speed up and improve the analysis process, leading to improvement in the overall software quality and reduced costs.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments disclosed herein are related to systems, methods, and computer readable medium for determining patterns of related attributes in failure data that are indicative of an underlying cause of a computing operation failure. In one embodiment, a system includes a processor and a system memory. The system instantiates in the system memory an aggregation module that groups accessed data, which may be failure data, into subsets. The data is associated with attributes, which may be categorical attributes, that describe information related to the accessed data. The subsets include data having matching combinations of the attributes. The system also instantiates in the system memory an expand module that iteratively removes, for the subsets, attributes of the combination of attributes associated with each subset to increase the amount of data included in the subsets. The system also instantiates in the system memory a score module that scores each subset, after iteratively removing attributes, to determine patterns related to the combination of attributes. In another embodiment, recorded data is received. The data is associated with attributes that describe information corresponding to the data. The data and the associated attributes are organized into a table having rows corresponding to the received data and columns corresponding to the one or more attributes. The table is reorganized into subsets of data based on a count representing an amount of the data having matching combinations of the attributes. For each of the subsets, attributes of the combination of attributes associated with each subset are iteratively removed to increase the count representing the amount of data included in each subset. After iteratively removing the attributes, each subset is scored to determine one or patterns related to the combination of attributes most.

In an additional embodiment, accessed data is grouped into one or more subsets. The data is associated with one or more attributes that describe information related to the data. The one or more subsets have matching combinations of the attributes. For each of the subsets, attributes of the combination of attributes associated with each subset are iteratively removed to thereby increase the amount of data included in the subset. After iteratively removing the attributes, each subset is scored to determine one or more patterns related to the combination of attributes.

Additional features and advantages will be set forth in the description, which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates a computing system in which some embodiments described herein may be employed;

FIG. 2 illustrates an embodiment of a computing system that is able to determine patterns of related attributes in failure data that are indicative of an underlying cause of a computing operation failure;

FIGS. 3A-3H illustrate embodiments of a failure record table that is used to determine patterns of related attributes that are indicative of an underlying cause of a computing operation failure;

FIG. 4 illustrates a flow chart of an example method determining patterns of related attributes in failure data that are indicative of an underlying cause of a computing operation failure; and

FIG. 5 illustrates a flow chart of an alternative example method for determining patterns of related attributes in failure data that are indicative of an underlying cause of a computing operation failure.

### DETAILED DESCRIPTION

With the increasing transition of software applications from on-premises to cloud based solutions, telemetry data is collected more than ever and Application Performance Management (APM) is becoming an increasingly important part of software applications' success. With the increase of APM, there is also a growing need for log analysis, especially the analysis of failures in computing operations. The ability to efficiently mine failure logs may speed up and improve the analysis process, leading to improvement in the overall software quality and reduced costs.

Accordingly, failure analysis has become a common APM task performed in order to improve application stability and quality. Failures in computing operations may include, but are not limited to, exceptions thrown during code execution, application crash, failed server requests or similar events. Failure events often contain various attributes indicating various properties such as geographical data, application version, error codes, operating systems, device types, and the like.

In many embodiments, there are two types of common failure sets. One is two class but highly imbalanced sets: the full set of failures is a small subset of a larger set containing both success and failure records. For example, for http: requests the full set of records may contain mostly successful requests (where the http: response is 200 or any other value <400), and only a small set of failures (where the http: response is 500 or any value >=400). A second set is pure one class sets: containing failure records only, wherein there are no non-failure records.

For the two class problem, conventional solutions typically use supervised learning methods, i.e. building a classifier to identify the failures out of the non-failures. General classification algorithms (e.g. decision trees, etc.) work well on a balanced set, but perform poorly (if at all) on imbalanced ones. Also these methods in general cannot operate on sets that are too small relative to the number of attributes due to over-fitting problems, which might be the common case for failures sets.

For the one class problem, conventional solutions will use clustering (unsupervised learning) methods. In general, clustering methods suffer from the following problems: (1) prior requirements such as definition of a distance function between any two records, which is hard to define and mostly irrelevant for categorical attributes, (2) clustering methods partition (excluding fuzzy ones) the set, i.e. any record belongs to a single cluster, which is problematic in the context of failure analysis where a specific failure can belong to few different clusters or no cluster at all, and (3) the representation of the found clusters is not intuitive or simple to filter.

Aspects of the disclosed embodiments relate to the creation and use of computing systems that find and implement high quality patterns to further investigate the full set of failures. The patterns (alias, segments or clusters) may be subsets of the full set of failures sharing many common categorical attributes. That is, the patterns are related to combinations of categorical attributes that are common across the subsets of the failures.

The disclosed embodiments provide a balance between an informative (i.e., contains many attributes) but not representative (i.e., too small) subset versus a representative, but not informative subset (i.e., too generic, containing a single attribute). The disclosed embodiments find the patterns and then rank them in order to expose to a user a small list of the top ranked patterns that may then be used for further exploration of the cause of the failure and/or that may hint about the root-cause of the failures.

There are various technical effects and benefits that can be achieved by implementing aspects of the disclosed embodiments. By way of example, the use of the patterns in the disclosed embodiments significantly reduces the amount of failure data that need to be explored to determine the cause of the failure, thus reducing the computer resources needed for APM processes. In addition, the technical effects related to the disclosed embodiments can also include improved user convenience and efficiency gains through a reduction in the time it takes for the user to discover the cause of the failures.

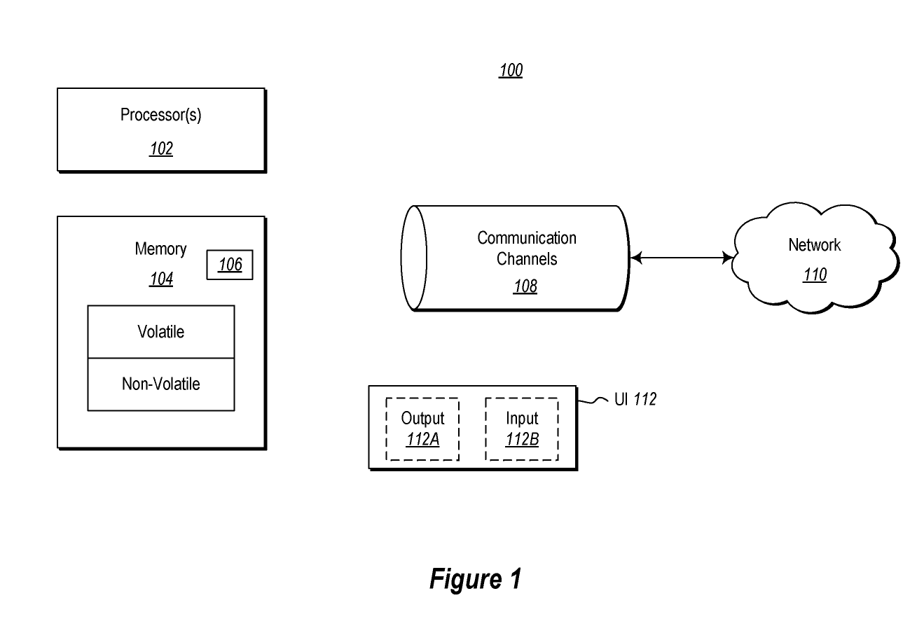

Some introductory discussion of a computing system will be described with respect to FIG. 1. Then, the performance of a computing system for determining patterns in data will be described.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor to thereby provision the computing system for a special purpose. The memory may take any form and may depend on the nature and form of the computing system. A computing system may be distributed over a network environment and may include multiple constituent computing systems.

As illustrated in FIG. 1, in its most basic configuration, the computing system 100 includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “controller”, “validator”, “runner”, “deployer” or the like, may also be used. As used in this description and in the case, these terms (regardless of whether the term is modified with one or more modifiers) are also intended to be synonymous with the term “executable component” or be specific types of such an “executable component”, and thus also have a structure that is well understood by those of ordinary skill in the art of computing.

In the description that follows, embodiments are described with reference to acts that are performed by one or more computing systems. If such acts are implemented in software, one or more processors of the associated computing system direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100.

The computer-executable instructions may be used to implement and/or instantiate all of the disclosed functionality. The computer-executable instructions are also to implement and/or instantiate all of the interfaces disclosed herein, including the analysis view windows and graphics.

Computing system 100 may also contain communication channels 108 that allow the computing system 100 to communicate with other message processors over, for example, network 110.

Embodiments described herein may comprise or utilize special-purpose or general-purpose computer system components that include computer hardware, such as, for example, one or more processors and system memory. The system memory may be included within the overall memory 104. The system memory may also be referred to as “main memory,” and includes memory locations that are addressable by the at least one processing unit 102 over a memory bus in which case the address location is asserted on the memory bus itself. System memory has been traditionally volatile, but the principles described herein also apply in circumstances in which the system memory is partially, or even fully, non-volatile.

Embodiments within the scope of this disclosure also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage devices that store computer-executable instructions and/or data structures. Physical hardware storage devices include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Alternatively, or in addition, the functionality described herein can be performed, at least in part, by one or more hardware logic components. For example, and without limitation, illustrative types of hardware logic components that can be used include: Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

When the referenced acts of the disclosed methods are implemented in software, the one or more processors 102 of the computing system 100 perform the acts and direct the operation of the computing system 100 in response to having executed the stored computer-executable instructions defined by the software. Various input and output devices such as display 112 can be used by the computing system to receive user input and to display output in accordance with the computer-executable instructions.

While not all computing systems require a user interface, in some embodiments, the computing system 100 may include a user interface for use in interfacing with a user. The user interface may include output mechanisms as well as input mechanisms. The principles described herein are not limited to the precise output mechanisms or input mechanisms as such will depend on the nature of the device. However, output mechanisms might include, for instance, speakers, displays 112, tactile output, holograms, virtual reality, and so forth. Examples of input mechanisms might include, for instance, microphones, touchscreens, holograms, cameras, keyboards, mouse of other pointer input, sensors of any type, and so forth. In accordance with the principles describe herein, alerts (whether visual, audible and/or tactile) may be presented via the output mechanism.

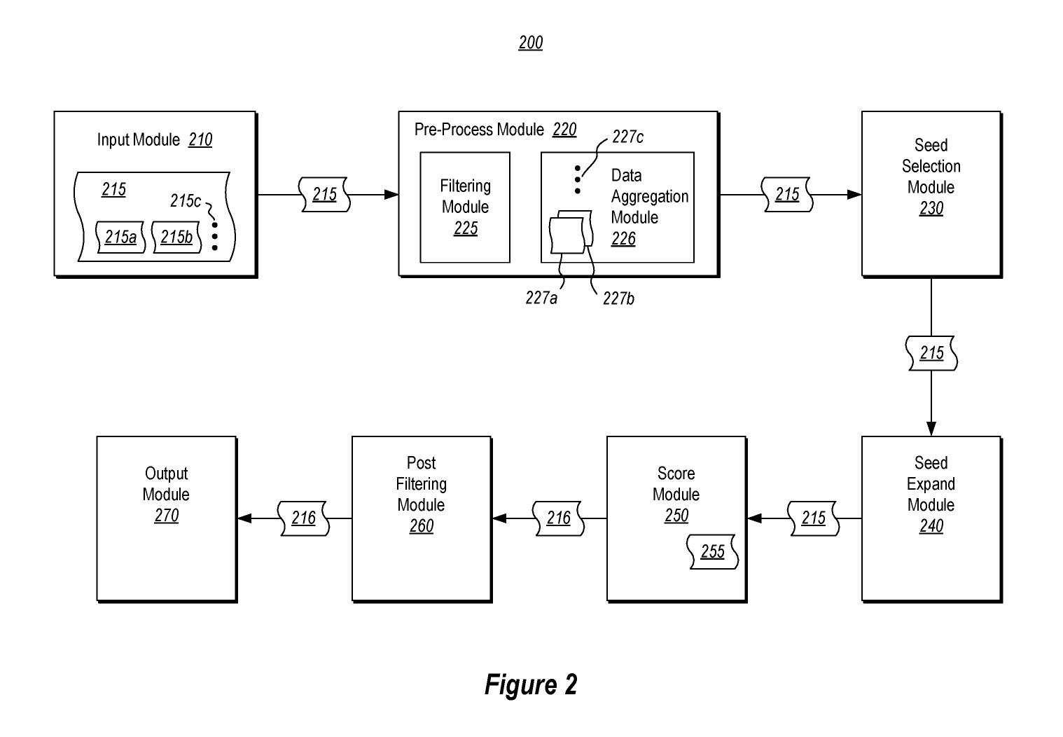

Attention is now given to FIG. 2, which illustrates an embodiment of a computing system 200, which may correspond to the computing system 100 previously described. The computing system 200 includes various modules or functional blocks that may determine various patterns that may be used to further investigate the full set of failures as will be explained. The various modules or functional blocks of computing system 200 may be implemented on a local computing system or may be implemented on a distributed computing system that includes elements resident in the cloud or that implement aspects of cloud computing. The various modules or functional blocks of the computing system 200 may be implemented as software, hardware, or a combination of software and hardware. The computing system 200 may include more or less than the modules illustrated in FIG. 2 and some of the modules may be combined as circumstances warrant. Although not illustrated, the various modules of the computing system 200 may access and/or utilize a processor and memory, such as processor 102 and memory 104, as needed to perform their various functions.

As illustrated in FIG. 2, the computing system 200 includes a data input module 210. In operation, the data input module 210 receives or accesses data 215 from a source that is typically external to the computing system 200. The data 215 may be any type of data and may correspond to a table or the like that includes multiple records and their associated attributes 215a, 215b, and any number of additional attributes as shown by ellipses 215c. Examples of the data 215 include any data that is placed in a table such as Excel and includes, but is not limited to sales data, customer usage data, and production data. The attributes 215a, 215b, and 215c describe information related to the data 215.

Accordingly, the embodiments and the claims disclosed herein are not limited by the type of the data 215 and their associated attributes 215a, 215b, and 215c. In one specific embodiment, the data 215 may be failure data. Since this embodiment will be described herein in most detail, the data 215 will also hereinafter be called “failure data 215” for ease of explanation. However, it will be appreciated that the description of data mining using patterns for the failure data 215 may also apply to any other type of data 215. Accordingly, one of skill in the art will appreciate after reading this specification that data mining using patterns as described herein may be performed on any type of data 215.

The embodiment of using failure data 215 that is to be subjected to data mining using the patterns to help analyze failures will now be explained in more detail to follow. The failure data 215 may correspond to a table or the like that includes multiple failure records and their associated attributes 215a, 215b, and any number of additional attributes as shown by ellipses 215c. The failure data may include exceptions thrown during code execution, application crashes, failed server requests or similar events. The failure data may also include data latencies. It will be appreciated that the embodiments disclosed herein are not limited by the type of the failure data 215.

The attributes may include information about the failure data such as geographical data, application version data, error codes, operating system and version data, device type, or the like. It will be appreciated that there may be any number of different types of attributes and that the embodiments disclosed herein are not limited by the types of attributes that are associated with the failure data 215. In some embodiments, the attributes 215a, 215b, and 215c may be categorical attributes or other types of attributes such as numerical or discrete attributes. In some embodiments, an attribute may be considered categorical if a small subset of its values covers a large portion of the failure data 215. The failure data 215 may be received from any reasonable source as circumstances warrant, for example from a database that is designed to store the failure data 215.

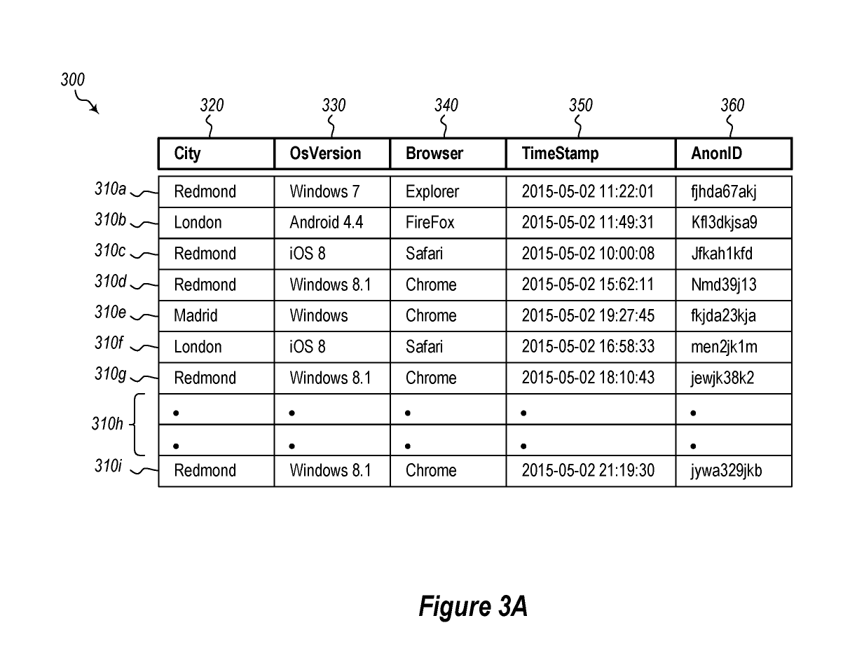

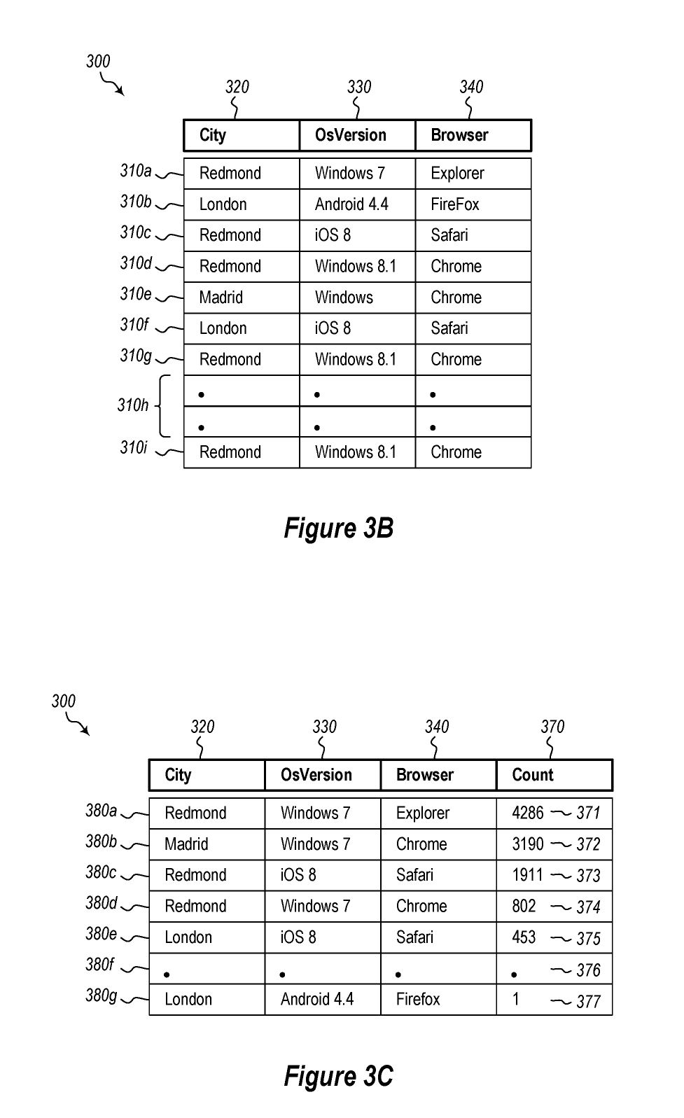

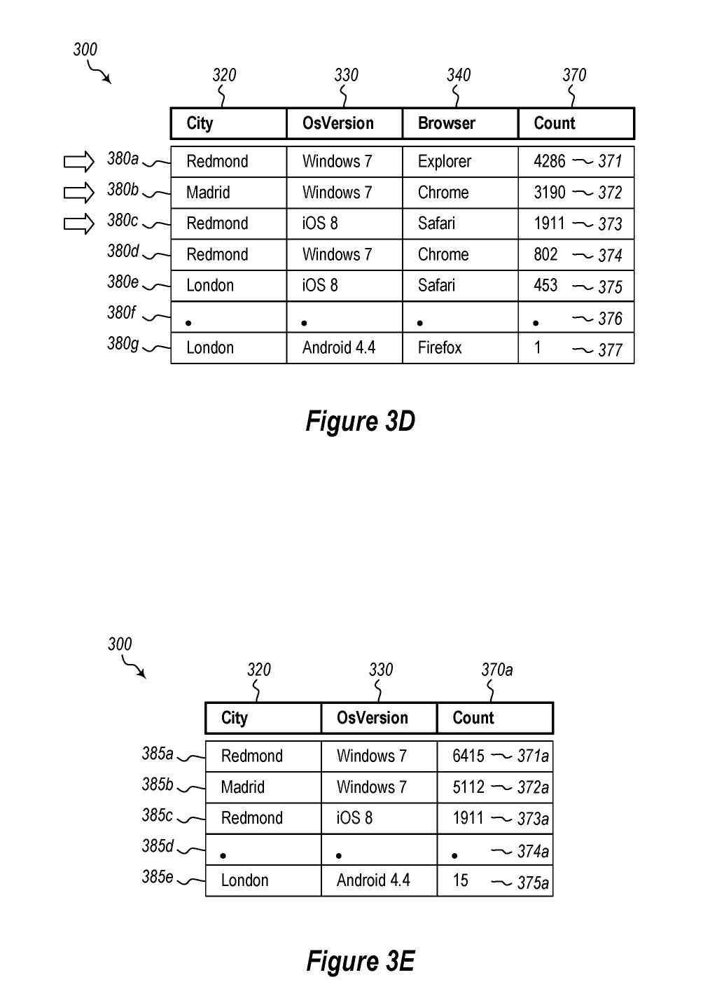

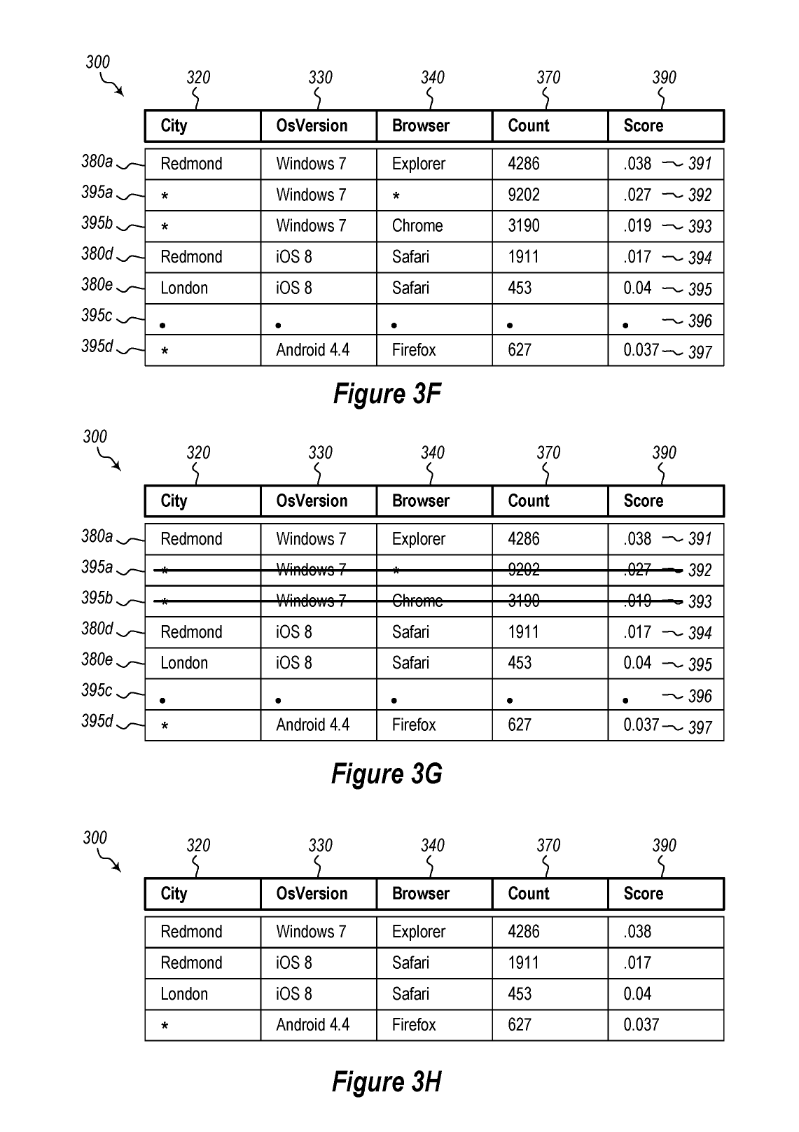

Turning now to FIG. 3A, an example embodiment of failure data 215 shown as a failure record table 300 is illustrated. As shown in FIG. 3A, the failure data table 300 includes multiple failure data records 310a-310i (also referred herein after as “failure data records 310”) that may correspond to the failure data 215 caused by any of the failures previously discussed. It will be noted that the dots shown for failure data records 310h represent that there may be numerous additional failure data records included in the failure record table 300 and typically the table 300 will include a large number of failure data records. It will be further noted that the failure record table is a simplified version that is used to illustrate the embodiments disclosed herein. Accordingly, the actual structure of the data table 300 should not be used to limit the embodiments disclosed herein.

As also shown in FIG. 3A, the failure data records 310 are associated with various attributes 320, 330, 340, 350, and 360 that may correspond to attributes 215a, 215b, and 215c. As shown, attribute 320 corresponds to geographical information, in this case the city where the failure occurred. Attribute 330 corresponds to an operating system version of a computer running the application where the failure occurred. Attribute 340 corresponds to a browser version running the application where the failure occurred. Attribute 350 includes time stamps of when the failure occurred and attribute 360 includes an ID of a user. It will be appreciated that there may be any additional number of attributes associated with the failure data records 310. For example, in an embodiment having 10,000 failure records 310, the additional failure records 310h may include 9,992 while the other eight are illustrated as records 310a-310g and 310i. Accordingly, the attributes 320, 330, and 340 may only have a few values in the table 300 since only a small number of the 10,000 records will be associated with a given one of the attributes 320, 330, and 340. The attributes 350 and 360, however, may have thousands of values since most, if not all, of the 10,000 records will be associated with these attributes.

Accordingly, the failure record 310a is associated with Redmond (attribute 320 City), Windows 7 (attribute 330 OS Version), Explorer (attribute 340 Browser), 2015-05-02 11:22:01 (attribute 350 Time Stamp), and fjhda67akj (attribute 350 Anon ID). The other failure data records 310 are associated with attributes in a similar manner.

In FIG. 3A, attributes 320, 330, and 340 are categorical attributes because a small subset of these attributes cover a large portion of the failure data records 310. For example, the attribute 320 City includes five instances of Redmond and two of London, the attribute 330 OS Version includes multiple instances of several of the operating systems, and the attribute 340 Browser includes multiple instances of several of the various browsers. In contrast, the attribute 350 Time Stamp, which is a numerical attribute, and attribute 360 Anon ID are considered non-categorical attributes because a subset of these attributes does not typically cover a large portion of the failure data records. In the illustrated embodiment, the listed time stamps and user IDs are only associated with a single failure record 310.

Returning to FIG. 2, the computing system 200 may also include a preprocess module 220 that is configured to provide preprocessing on the failure data 215. In one embodiment, the preprocessing module 220 may include a filtering module 225 that is configured to perform filtering based on the attributes. For example, in one embodiment, the filtering module 225 may, for each attribute 215a, 215b, and 215c, analyze the distribution of its value on all the failure data 215, keeping only attributes where the vast majority of records are contained in a small number of values while filtering away attributes who have a spread distribution. The filtering module 225 may also provide data cleansing and other related procedures.

The preprocessing module may also include a data aggregation module 226. In operation, the data aggregation module 226 aggregates or groups the failure data 215 into one or more subsets of the failure data 227a, 227b, or any number of additional subsets as illustrated by the ellipses 227c (hereinafter referred to as subsets 227) based on matching or shared combinations of the categorical attributes 215a, 215b, and 215c. That is, the data aggregation module 226 aggregates the failure data by grouping all the failure data records that are related by having matching combinations of specific attributes into the subsets 227. For example, in one embodiment, the data aggregation module may aggregate or group all of the failure data records 310 that include the same combination of attributes into the same subset, such as subset 227a. A count of the number or amount of the failure data records 310 in each subset 227 may also be provided as illustrated at 370.

In other words, since the failure data records 310 are often characterized by highly dense regions in the data space, meaning that many rows are exact duplicates over the set of relevant columns, it may be useful to compute the aggregate table of duplicate row counts. Once this is computed, the complexity of the failure data 215 is reduced from linear in the total number of rows, to linear in the number of distinct rows, which can often be several orders of magnitude smaller. Thus, when a row of the failure data table matches the pattern under consideration, a “count” column that may be incremented may be added to the data table (see FIG. 3C).

FIG. 3B illustrates a specific example of the operation of the filtering module 225. As shown in FIG. 3B, the filtering module 225 filters out the attributes 350 timestamp and 360 user ID from the failure data records 310. In this embodiment, the filtering module is configured to filter out non-categorical attributes such as attributes 350 and 360. It will be noted that use of the attributes 350 and 360 to find the patterns in the data mining may return too large a number of patterns up to the extreme case where the number of patterns would equal the number of data records since there would be a single pattern per data record. In other embodiments, the filtering module 225 may be configured to not filter out non-categorical attributes, but may use different criteria for filtering.

FIG. 3C illustrates an example of the operation of the data aggregation module 226. FIG. 3C shows the failure data table 300 after the data aggregation module 226 has aggregated or grouped the failure data records 310 into the subsets 227 based on the matching combinations of the categorical attributes. As illustrated, the table 300 shows aggregated failure data records or subsets 380a-380g (also referred to as simply “subsets 380”), with subset 380f showing that there can be any number of subsets 380.

FIG. 3C also shows a count column 370 in the table 300. The count column includes counts 371-377 that show the number or amount of instances of the failure data records 310 in a given subset 380. For example, the table 300 shows that the subset 380a includes 4286 instances as designated at 371, the subset 380b includes 3190 instances as designated at 372, the subset 380c includes 1911 instances as designated at 373, the subset 380d includes 802 instances as designated at 374, the subset 380e includes 453 instances as designated at 375, and the subset 380g includes 1 instance as designated at 377. Accordingly, the aggregated failure data table 300 is ordered from the subset with the most populated combination of attributes to the subset with the least populated combination.

Returning to FIG. 2, the computing system 200 further includes a seed selection module 230. In operation, the seed selection module 230 receives the aggregated failure data 215 from the preprocess module 220. The seed selection module may then designate the top k number of aggregated rows, for example aggregated failure records or subsets 380, to use as “seeds” for further processing. In some embodiments, the top k number of aggregated rows used as seeds is about 20. However, in other embodiments the top k number of aggregated rows used as seeds may be as low as one row or it may be more than 20. The top k number of aggregated rows that are selected to be used as seeds is often based on a trade-off between the quality of the patterns that are found and computing resources. Typically, the greater the number of seeds, the better the quality of the patterns, but the higher the computing resources that are required. Accordingly, the embodiments disclosed herein are not limited by the number of aggregated rows that are selected to be used as seeds.

FIG. 3D illustrates an example of the operation of the seed selection module 230. As illustrated in FIG. 3D, the seed selection module 230 selects the top three subsets 380a, 380b, and 380c as the top k number of aggregated rows. In other words, three seeds are selected in the example. This is indicated by the large arrows next to the subsets 380a, 380b, and 380c.

Returning to FIG. 2, the computing system 200 additionally includes a seed expand module 240. In operation, the seed expand module 240 expands each “seed” (i.e., a single row out of the top k number of aggregated rows) in order to locally increase the count 370 by dropping a single attribute (e.g. 320, 330, or 340). For each seed, at each stage one column is dropped in a greedy selection, the dropped column being the one that maximizes the count 370 captured by the expanded pattern (i.e., combination of attributes). In other words, each selected seed goes through iterative “growing” steps. In each step a single attribute is removed and a new and bigger count is calculated. The removed attribute is the one causing the highest increase in the count.

Shown below is an example of pseudocode that may be implemented by the seed expand module 240 to expand the seeds in the manner described.

Seed Expand

```
input:
X datatable
seed initial seed to start from
output:
L List of candidate patterns
1:  C ← all columns in seed
2:  R ← all rows of X in the seed segment
3:  L ← empty list
4:  while C is not empty do
5:  Add (R, C) to L
6:  for each column c in C do
7:  value(c) ← the number of rows in X fitting
      the segment with columns C \ {c} and the
      values in seed
8:  end for
9:   c* ← argmax value(c)
10:  C ← C \ {c*}
11:  R ← rows of X agreeing with seed on columns C
12: end while
13: return: L
```

FIG. 3E illustrates an example of the operation of the seed expand module 240. FIG. 3E shows the iterative step of removing an attribute. In this case, the attribute 340 Browser is removed to generate a new, larger count 370a. For example, removing attribute 340 Browser causes subsets 380a and 380d to combine along with other non-illustrated subsets to create expanded subset 385a. That is, once the attribute 340 Browser is removed, subsets 380a and 380d are left with matching attribute combinations of attribute 320 City (Redmond) and attribute OS Version 330 (Windows 7). Combing these records and the other non-illustrated subsets that have matching attribute combinations of attribute 320 City (Redmond) and attribute OS Version 330 (Windows 7) to create the expanded subset 385a increases the count for the expanded subset 385a to 6415 as designated at 371a. In like manner, expanded subsets 385b-385e are generated by combining several of the subsets 380. The expanded subsets 385b-385e include new, larger counts 372a-375a respectively as shown in the figure.

Although not shown, the seed expand module 240 may also perform the iterative step of removing the attribute 320 City and the iterative step of removing the attribute OS Version 330. Further, the seed expand module 240 may perform iterative steps where all but one attribute is removed to increase the count or even where all the attributes are removed. In this way, different patterns from the seed containing all attributes, then all attributes minus 1, all attributes minus 2 . . . up to a pattern containing a single attribute may be generated from each seed.

Returning to FIG. 2, the computing system 200 may also include a score module 250. In operation, the score module calculates a heuristic score 255 for each pattern discovered by the seed expand module 240 by balancing between informative (specific) patterns of combinations of attributes covering small subsets versus generic patterns of combinations of attributes covering large subsets. The score 255 may be a measure of how much of the failure data 215 is covered by a given pattern. It will be noted that a pattern that covers a larger amount of the failure data may be more useful in helping to determine the root cause of the failure.

In one embodiment, the score module 250 determines the score 255 for a given pattern in view of the total number of attributes. For example, if the total number of attributes is 10 and a given pattern of combinations of attributes for an expanded subset, such as a subset 385 of FIG. 3E, includes six of the 10 attributes, then the score 255 would be 0.6 or 60%. This represents an “informative score” that indicates how informative the pattern is. A larger number for the informative score is more informative than a smaller number. The number of failure records out of the total number of failure records that are covered by the pattern represents a “size score”. It will be noted that while a larger informative score will be more informative, it may return a size score. On the other hand, a smaller informative score may result in a larger size score, but it may not be as informative. Accordingly, a trade-off may be needed between the informative score and the size score when determining the score 255.

In some embodiments, the score module 250 multiplies the informative score by the size score and uses the product as the score 255. This score reflects the trade-off between the informative score and the size score. In other words, it shows how informative a pattern is given its coverage of the failure data. It will be appreciated that the score module 250 may use other scoring procedures and so the embodiments disclosed herein are not limited by how the score is determined.

Shown below is an example of pseudocode that may be implemented by the score module 250 to determine the score 255 in the manner described.

Iter Seeds

Input:
X datatable
k number of seeds to start from
s scoring function
output:
R, C subsets of the rows and columns attaining the max score
1: Aggregate X as duplicate-counts; sort by count descending.
2: score ← 0; R,C ← null
3: for i := 1, ..., k do
4: seed ← record i of X
5: candidates = seed-expand(seed, X)
6: for each R′, C′ in candidates do
7: if s(R′, C′) > score then
8: R,C,score ← R′, C′ , s(R′, C′)
9: end if
10: end for
11: end for
12: return: R,C

FIG. 3F illustrates an example of the operation of the score module 250. As shown, the score module 250 determines a score 391-397, corresponding to the score 255, in the manner previously discussed for each of the patterns (i.e., combination of attributes) shown in the failure data table 300. In the illustrated embodiment, the failure data is listed from highest to lowest score. For example, the record 380a having a pattern of City 320 Redmond, OS Version 330 Windows 7, and Browser 340 Explorer is given a score 391 of 0.38, which is the highest score. In like manner, the records 395a-395d, 380d, and 380e having the patterns shown in FIG. 3F are given scores 392-397 in descending order as shown. It will be noted that in FIG. 3F, an “*” represents that any value may be included in the pattern for that given attribute.

In some embodiments, the computing system 200 may include a post-processing module 260. In operation, the post-processing module 260 receives the scored results 216 from the score module 260 and then may be configured to filter out patterns covering highly overlapped subsets of the results. In some embodiments, the filtering may be done either by a symmetrical similarity measure (e.g., Jaccard Index) or by asymmetrical subset filtering, such that no pattern is pure subset of another. In other embodiments, other types of filtering may be used. Accordingly, the embodiments disclosed herein are not limited by the type of filtering that may be performed.

FIG. 3G shows the results of filtering the results 216. As shown, the post-filtering module 260 has filtered out the pattern of records 395a and 395b since they highly overlap the pattern of record 380a.

The computing system 200 may further include an output module 270. In operation, the output module may receive the results 216 from the post-filtering module or, in those embodiments that do not include a post-filtering module 260, from the score module 250. The output module may provide the results 216 to an end user, who may then use the results to further investigate the highly scored patterns as these patterns are more likely to provide information about the root cause of the failure.

FIG. 3H shows an example of the output 216 that is output by the output module 270. As illustrated, the table 300 includes the top four scored patterns after filtering out overlapping patterns. As will be appreciated, the small number of patterns provided to the user may be more helpful than a large number of patterns since, as previously described, the top scored patterns are more likely to provide information about the root cause of the failure. An end-user may then be able to use the information in the table 3H in the analysis of root cause of the failures.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

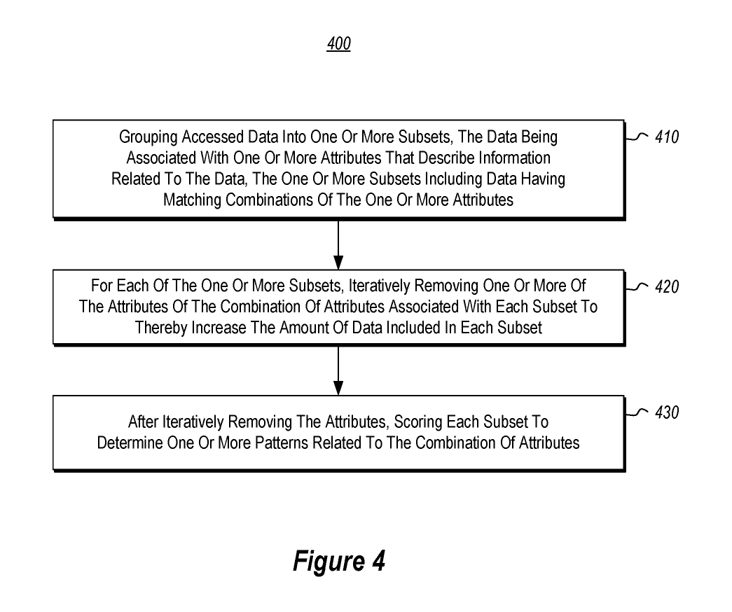

FIG. 4 illustrates a flow chart of an example method 400 for determining patterns of related attributes in accessed data. The method 400 will be described with respect to FIGS. 2 and/or 3A-3H discussed previously.

The method 400 includes grouping accessed data into one or more subsets (act 410) (act 410). The data may be associated with one or more attributes that describe information corresponding to the data records. The one or more subsets may include data that have matching combinations of the one or more attributes.

For example, as previously discussed, in one non-limiting embodiment the data aggregation module 226 may group or organize failure data into the subsets 227 based on the combinations of the attributes 215a, 215b, and 215c shared by failure data 215. As previously discussed, FIG. 3C shows an example of the failure data 215 grouped into subsets 380 based on the matching or shared combinations of the one or more attributes 310, 320, and 330. The input module 210 may receive or access the failure data 215, which may correspond to computing operations failures such as exceptions thrown during code execution, application crash, failed server requests or similar events. The failure data may also include data latencies. In some embodiments, the failure record 215 may correspond to a table such as the table 300 of FIGS. 3A-3G. The failure data 215 may include multiple failure data records and their corresponding attributes 215a, 215b, and 215c. The attributes may include information about the failure data such as geographical data, application version data, error codes, operating system and version data, device type, or the like.

The method 400 includes, for each of the one or more subsets, iteratively removing one or more of the attributes of the combination of attributes associated with the subset to thereby increase the amount of data included in each subset (act 420). For example, as previously described, in the non-limiting embodiment the seed expand module 240 may iteratively remove one or more of the attributes 215a, 215b, and 215c associated with one of the subsets 227 to increase the amount of failure data 215 included in the subsets 227. As previously discussed, FIG. 3E shows an example of this process.

The method 400 includes, after iteratively removing the attributes, scoring each subset to determine one or patterns related to the combination of attributes (act 450). For example, as previously discussed, in the non-limiting embodiment the score module 250 scores the subsets 227 to determine the pattern of the combination of attributes 215a, 215b, and 215c. In the non-limiting embodiment, this pattern in the pattern that is likely to be a cause of one or more failures of the computing operation. As previously discussed, FIG. 3F shows an example of this process.

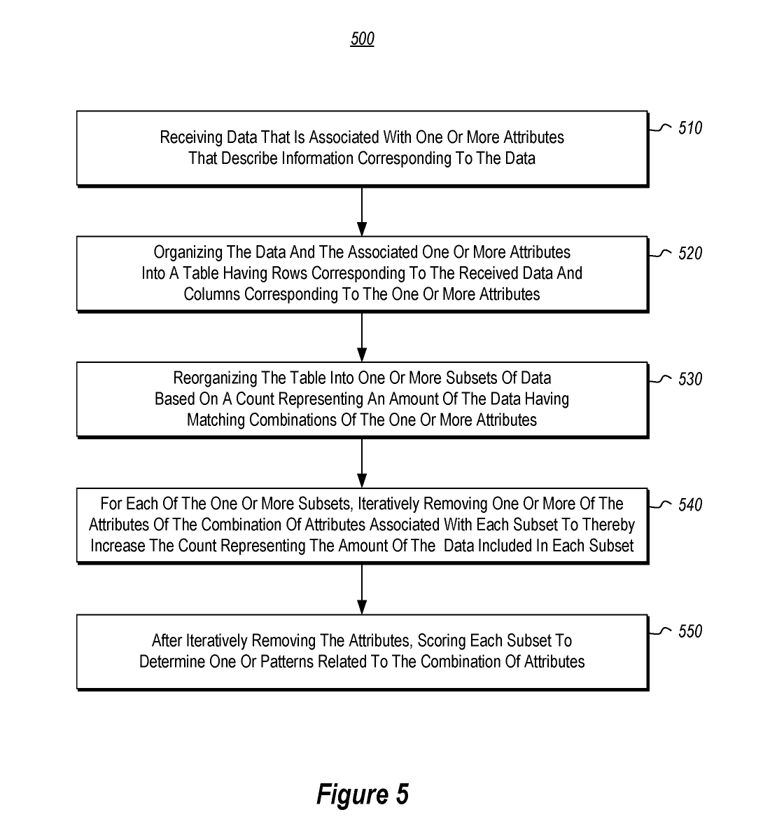

FIG. 5 illustrates a flow chart of an example method 500 for determining patterns of related attributes in recorded data. The method 500 will be described with respect to FIGS. 2 and/or 3A-3H discussed previously.

The method 500 includes receiving data that is associated with one or more attributes that describe information corresponding to the data (act 510). For example, as previously discussed, in one non-limiting embodiment the input module 210 may receive the failure data 215, which may correspond to computing operations failures such as exceptions thrown during code execution, application crash, failed server requests or similar events. The failure data may also include data latencies. The failure data 215 may include multiple failure data records 310 and their corresponding attributes 215a, 215b, and 215c or 310-340. The attributes may include geographical data, application version data, error codes, operating system and version data, device type, or the like.

The method 500 includes organizing the data and the associated one or more attributes into a table (act 520). The table may have rows corresponding to the data and columns corresponding to the one or more attributes. For example, in the non-limiting embodiment the failure data 215 may be organized by the data aggregation module 230 into the failure record table 300 that has rows corresponding to the failure data records 310 and columns corresponding to attributes 320, 330, and 340 as shown in FIG. 3A.

The method 500 includes reorganizing the table into one or more subsets of data based on a count representing an amount of the data having matching combinations of the one or more attributes (act 530). For example, in the non-limiting embodiment the data aggregation module 230 may reorganize the failure record table 300 into the subsets 380 as shown in FIG. 3C. This may be based on a count of the amount of the failure data records that have matching combinations of attributes as previously described.

The method 500 includes for each of the one or more subsets, iteratively removing one or more of the attributes of the combination of attributes associated with each subset to thereby increase the count representing the amount of the data included in each subset (act 540). For example, as previously described, in the non-limiting embodiment the seed expand module 240 may iteratively remove one or more of the attributes 320, 330, and 340 associated with one of the subsets 380 to increase the count 371a-375a representing the amount of failure data records 310 included in the subsets 385 after the iterative process. For instance, FIG. 3E illustrates that, removing attribute 340 Browser causes subsets 380a and 380d to combine along with other non-illustrated subsets to create expanded subset 385a, which has an increased count 371a.

The method 500 includes after iteratively removing the attributes, scoring each subset to determine one or more patterns related to the combination of attributes (act 550). For example, as previously discussed, in the non-limiting embodiment the score module 250 scores the subsets 380 with a score 391-397 that are used to determine the pattern of the combination of attributes 320, 330, and 340. In the non-limiting embodiment this is the pattern that is likely to be a cause of the one or more failures of the computing operation.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A computing system comprising:
at least one processor; and
system memory having stored thereon computer-executable instructions which, when executed by the at least one processor, cause the following to be instantiated in the system memory:
an aggregation module configured to group accessed data into one or more subsets, the data being associated with one or more attributes that describe information related to the data, the one or more subsets including data having matching combinations of the one or more attributes;
an expand module configured to iteratively remove, for each of the one or more subsets, one or more of the attributes of the combination of attributes associated with the subset to thereby increase the amount of data included in each of the subsets; and
a score module configured to score each subset, after iteratively removing the one or more attributes, to determine one or more patterns related to the combination of attributes.

2. The system of claim 1, wherein the data is failure data that is indicative of a failure of a computing operation and wherein the one more patterns are indicative of the combination of attributes most likely to cause a failure of a computing operation.

3. The system of claim 1, wherein the executed computer executable instructions further instantiate in the system memory:
a selection module configured to select the one or more subsets having the largest amount of data.

4. The computing system according to claim 1, wherein the one or more attributes are categorical attributes.

5. The system according to claim 1, wherein the executed computer executable instructions further instantiate in the system memory:
a filtering module configured to filter out non-categorical attributes from the f data prior to the data being grouped by the aggregation module.

6. The system according to claim 1, wherein the executed computer executable instructions further instantiate in the system memory:
a post-filtering module configured to filter out one or more patterns covering overlapped subsets that have similar scores.

7. The system according to claim 1, wherein the executed computer executable instructions further instantiate in the system memory:
an output module configured to provide the one or more patterns to an end user.

8. The system according to claim 1, wherein the received data is organized into a table, the table including rows corresponding to the data and columns corresponding to the one or more attributes.

9. The system according to claim 1, wherein the data is failure data that is indicative of one or more failures of a computing operation, the failure data including one or more of exceptions thrown during code execution, application crashes, failed server requests or data latencies.

10. The system according to claim 1, wherein the attributes include one or more of geographical data, application version data, error codes, operating system version data, and device type information.

11. The system according to claim 1, wherein the aggregation module is configured to group each subset by generating a count of the data that includes the same combination of attributes.

12. The system according to claim 1, wherein the scoring module is configured to score each subset by balancing between informative patterns covering small subsets versus generic patterns covering large subsets.

13. A computerized method for determining patterns of related attributes in recorded data, the method comprising:
an act of receiving, at a processor of the computing system, data that is associated with one or more attributes that describe information corresponding to the data;
an act of organizing the data and the associated one or more attributes into a table having rows corresponding to the received data and columns corresponding to the one or more attributes;
an act of reorganizing the table into one or more subsets of data based on a count representing an amount of the data having matching combinations of the one or more attributes;
for each of the one or more subsets, an act of iteratively removing one or more of the attributes of the combination of attributes associated with each subset to thereby increase the count representing the amount of the data included in each subset; and
after the act of iteratively removing the attributes, an act of scoring each subset to determine one or patterns related to the combination of attributes.

14. The method according to claim 13, wherein the data is failure data and wherein the one more patterns are indicative of the combination of attributes most likely to cause a failure of a computing operation.

15. The method according to claim 13, further comprising:
an act of selecting one or more subsets having the largest count prior to the act of iteratively removing one or more of the attributes of the combination of attributes.

16. The method according to claim 13, wherein the one or more attributes are categorical attributes.

17. The method according to claim 13, wherein the data is failure data that is indicative of one or more failures of a computing operation, the failure data including one or more of exceptions thrown during code execution, application crashes, failed server requests or data latencies.

19. A computer program product comprising one or more hardware storage devices having thereon computer-executable instructions that are structured such that, when executed by one or more processors of a computing system, configure a computing system to perform a method for determining patterns of related attributes in accessed data, the method comprising:
grouping accessed data into one or more subsets, the data being associated with one or more attributes that describe information related to the data, the one or more subsets including data having matching combinations of the one or more attributes;
for each of the one or more subsets, iteratively removing one or more of the attributes of the combination of attributes associated with each subset to thereby increase the amount of data included in each subset; and
after iteratively removing the attributes, scoring each subset to determine one or more patterns related to the combination of attributes.

20. The computer program product according to claim 19, wherein the attributes are categorical attributes and wherein the data is failure data.
